(19) United States
(12) Patent Application Publication
(10) Pub. No.: US 2025/0165688 A1
(43) Pub. Date: May 22, 2025

(54) METHOD AND APPARATUS FOR CONDITIONAL FAULT MODELLING

(71) Applicant: TEXAS INSTRUMENTS INCORPORATED, Dallas, TX (US)

(72) Inventors: Lakshmanan Balasubramanian, Bangalore (IN); Rubin Parekhji, Bangalore (IN); Supraja Ramakrishnan, Bangalore (IN)

(21) Appl. No.: 18/513,070

(22) Filed: Nov. 17, 2023

(51) Int. Cl. G06F 30/3308; G06F 119/02

(52) U.S. Cl. CPC G06F 30/3308; G06F 2119/02

(57) ABSTRACT

A method comprises creating an electronic circuit design having a plurality of electronic components, defining a fault condition imposable during a simulation of the electronic circuit design, and generating a simulation model based on the electronic circuit design. The method also comprises generating a simulation fault model representing the fault condition and executing a simulation of the simulation model to simulate operation of the electronic circuit design. During the execution of the simulation, the method comprises controlling the simulation fault model to begin an imposition of the fault condition within the simulation model, simulating circuit behavior of the simulation model in response to the imposition of the fault condition, controlling the simulation fault model to cease the imposition of the fault condition within the simulation model, and simulating circuit behavior of the simulation model in response to the cessation of the imposition of the fault condition.

### BACKGROUND

Modern circuit design often involves electronic design automation (EDA) tools to simulate and verify circuit operation and interconnections. Simulating the circuit design may validate not only the expected operational conditions of the circuit design but also conditions involving defects or faults injected in the circuit design for analysis. For example, a fault condition may be introduced into the simulation to determine a circuit response to the fault.

However, in current simulation methods, a defect/fault can be injected during the simulation, but the defect/fault will always remain effective for the rest of the simulation. That is, injected defects and/or faults cannot be withdrawn or made to expire before the end of the simulation once they are initiated. Furthermore, a defect or fault cannot be injected into or withdrawn from the simulation upon satisfying a specific condition including an electrical or logical state of the simulated circuit.

### SUMMARY

In accordance with one aspect, a method comprises creating an electronic circuit design having a plurality of electronic components, defining a fault condition imposable during a simulation of the electronic circuit design, and generating a simulation model based on the electronic circuit design. The method also comprises generating a simulation fault model representing the fault condition and executing a simulation of the simulation model to simulate operation of the electronic circuit design. During the execution of the simulation, the method comprises controlling the simulation fault model to begin an imposition of the fault condition within the simulation model, simulating circuit behavior of the simulation model in response to the imposition of the fault condition, controlling the simulation fault model to cease the imposition of the fault condition within the simulation model, and simulating circuit behavior of the simulation model in response to the cessation of the imposition of the fault condition.

In accordance with another aspect, an apparatus comprises one or more computer readable storage media and program instructions stored on the one or more computer readable storage media. The program instructions are executable by a processing system to direct the processing system to generate a simulation file based on a simulation model of a plurality of electronic components of an electronic circuit and based on a simulation fault model of a fault condition, execute the simulation file to simulate operation of the plurality of electronic components, and activate the simulation fault model during the execution of the simulation file to simulate application of the fault condition to one or more of the simulated plurality of electronic components. The program instructions further direct the processing system to simulate behavior of the plurality of electronic components in response to the activation of the fault condition, deactivate the simulation fault model during the execution of the simulation file to simulate removal of the fault condition from the one or more of the simulated plurality of electronic components, and simulate behavior of the plurality of electronic components in response to the deactivation of the fault condition.

### BRIEF DESCRIPTION OF THE DRAWINGS

In the drawings:

FIG. 1 is an example circuit diagram of a circuit to be simulated according to one or more disclosed implementations.

FIG. 2 illustrates a short defect/fault introduced into the circuit of FIG. 1 according to one or more disclosed implementations.

FIG. 3 illustrates an open defect/fault introduced into the circuit of FIG. 1 according to one or more disclosed implementations.

FIG. 4 illustrates a replacement defect/fault introduced into the circuit of FIG. 1 according to one or more disclosed implementations.

FIG. 5 illustrates multiple defects/faults introduced into the circuit of FIG. 1 according to one or more disclosed implementations.

FIG. 6 is a block diagram of a conditional simulation defect/fault model according to one or more disclosed implementations.

FIG. 7 illustrates an example circuit diagram of the circuit of FIG. 2 incorporating the conditional simulation defect/fault model of FIG. 6 to control the short circuit defect/fault condition according to one or more disclosed implementations.

FIG. 8 illustrates an example circuit diagram of the circuit of FIG. 3 incorporating the conditional simulation defect/fault model of FIG. 6 to control the open circuit defect/fault condition according to one or more disclosed implementations.

FIG. 9 illustrates an example circuit diagram of the circuit of FIG. 4 incorporating the conditional simulation defect/fault model of FIG. 6 to control the replacement defect/fault condition according to one or more disclosed implementations.

FIG. 10 is an example simulation functional waveform illustrating introduced and withdrawn defects/faults according to one or more disclosed implementations.

FIG. 11 is a flow diagram for designing and simulating chip functional behavior with introduced and withdrawn faults according to one or more disclosed implementations.

FIGS. 12A, 12B illustrate a pseudocode example useful for simulating defects/faults according to one or more disclosed implementations.

FIG. 13 is a block diagram of an example computer system that may be used to perform integrated circuit (IC) or System on Chip (SoC) simulation according to one or more disclosed implementations.

### DETAILED DESCRIPTION

In the following description, for purposes of explanation, numerous specific details are set forth in order to provide a thorough understanding of the examples disclosed herein. It will be apparent, however, to one skilled in the art that the disclosed example implementations may be practiced without these specific details. In other instances, structure and devices are shown in block diagram form in order to avoid obscuring the disclosed examples. Moreover, the language used in this disclosure has been principally selected for readability and instructional purposes and may not have been selected to delineate or circumscribe the inventive subject matter, resorting to the claims being necessary to determine such inventive subject matter. Reference in the specification to “one example” or to “an example” means that a particular feature, structure, or characteristic described in connection with the examples is included in at least one implementation.

As used herein, the term “medium” refers to one or more non-transitory physical media that together store the contents described as being stored thereon. Examples may include non-volatile secondary storage, read-only memory (ROM), and/or random-access memory (RAM).

As used herein, the term “application” refers to one or more computing modules, programs, processes, workloads, threads and/or a set of computing instructions executed by a computing system. Example implementations of applications and functions include software modules, software objects, software instances and/or other types of executable code.

As used herein, the terms “defect” and “fault” refer to characteristics of an electrical/electronic circuit or any other physical/chemical/biological/heterogeneous system modelled in terms of electrical/electronic components for the purpose of analysis not intended during circuit design. Such characteristics may represent anomalies of physical implementations of the designed circuit such as components having connections to nodes or other components outside of the intended design. For example, a defect or fault may introduce an electrical short between two nodes not meant to be shorted (e.g., a short to ground, a short to a supply rail, or a short together) or an electrical open between two nodes meant to be connected. The defect or fault may represent alteration of the value of one or more components due to age, temperature, current or voltage spikes, etcetera. Other types of defects and faults are also considered to be within the scope of this disclosure. Furthermore, the terms “defect” and “fault” are interchangeable, and it is to be understood that the mention of one in any portion of this disclosure also includes the other.

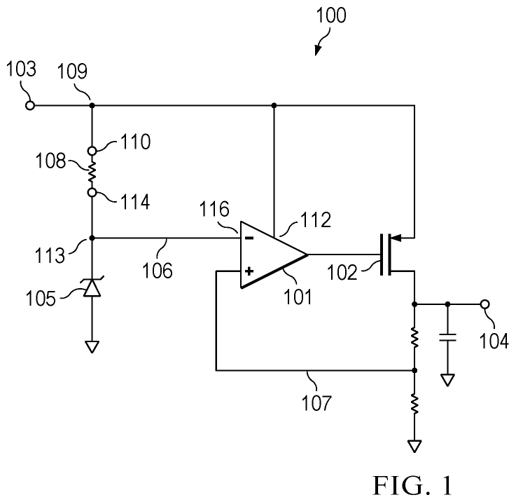

FIG. 1 is an example circuit diagram of an analog circuit such as a voltage regulator circuit 100 to be simulated according to an implementation. An operational amplifier (op. amp.) 101 is coupled with a power switch 102 such as a MOSFET for driving current from an input voltage terminal 103 through to an output voltage terminal 104 of the circuit 100. A constant reference component 105 such as a Zener diode provides a reference voltage 106 against which is compared a feedback voltage 107 that represents a scaled version of the output voltage supplied at the output voltage terminal 104. A resistor 108 is coupled between the input voltage terminal 103 and the constant reference component 105 to limit current supplied to the constant reference component 105. Based on the comparison of the feedback voltage 107 with the reference voltage 106 at the op. amp. 101, the power switch 102 is controlled to generate an output voltage that is a scaled version of the reference voltage 106.

A first common node 109 electrically couples the input voltage terminal 103 with a first terminal 110 of the resistor 108, the terminal 111 of the power switch 102, and an input power terminal 112 of the op. amp. 101. A second common node 113 electrically couples a second terminal 114 of the resistor 108, a first terminal 115 of the constant reference component 105, and an inverting input 116 of the op. amp. 101.

While the complexity of the voltage regulator circuit 100 illustrated in FIG. 1 may be deemed to be low, it is useful to illustrate incorporation of the embodiments of this disclosure as they apply to simulation of analog circuits. The described embodiments are applicable to low complex circuitry as well as high complex circuitry.

Simulation of the voltage regulator circuit 100 both in a non-faulty state as well as in a faulty state may be desired to verify operational status and robustness of the circuit. Simulation results of an ideal (e.g., a fault-free) reference circuit operation as well as operation of the circuit with introduced faults can provide insights into the circuit operation under a variety of scenarios. In particular, simulation results providing insight into how the circuit responds to cessation of a fault can be beneficial. In some examples, the cessation of the fault may occur as an intended result of the circuit to detect and eliminate the fault. In other examples, the cessation of the fault may occur independently of the operation of the circuit such as a fault that activates and deactivates due to environmental conditions like temperature, humidity, pressure, etcetera.

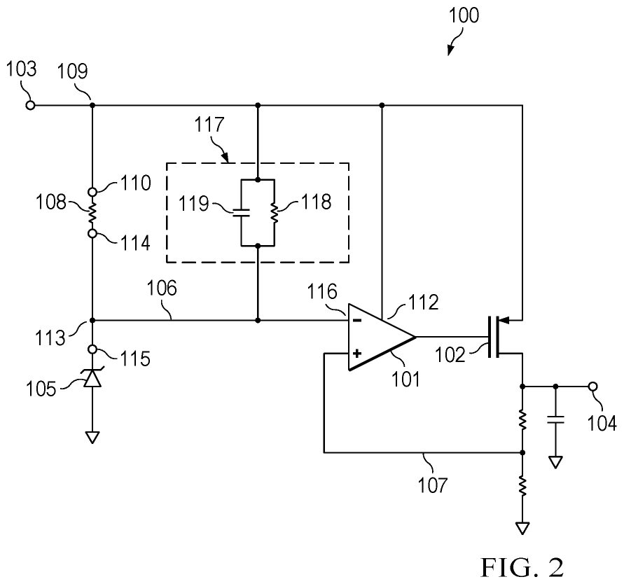

FIG. 2 illustrates an example short fault condition introduced into the voltage regulator circuit 100 of FIG. 1 according to an implementation. As illustrated in FIG. 1, the first and second nodes 109, 113 are separated by the resistor 108 and are not meant to be shorted together. A short fault between the first and second nodes 109, 113 alters the circuit behavior, and such altered behavior can be simulated according to embodiment of this disclosure.

Referring back to FIG. 2, a short fault condition may be represented by a short circuit fault condition 117 coupled between the first and second nodes 109, 113. As illustrated, the short circuit fault condition 117 is implemented via fault model components such as a fault resistor 118 (e.g., a low ohm resistor having a resistance much lower than the resistance of the resistor 108) coupled in parallel with a fault capacitor 119. In the embodiment shown in FIG. 2, the characteristics of the specific short circuit fault condition 117 intended to be tested during simulation may be best implemented by the parallel resistor/capacitor connection as shown. In other embodiments, a different shorting arrangement may be used between the first and second nodes 109, 113 to represent a different short fault. For example, the short circuit fault condition 117 may include only a single resistor, may include a zero-ohm short, or may include any combination of components configured to illustrate behavior of the desired fault condition during simulation. When activated during simulation, the effects of shorting the first common node 109 to the second common node 113 via the short circuit fault condition 117 can be simulated.

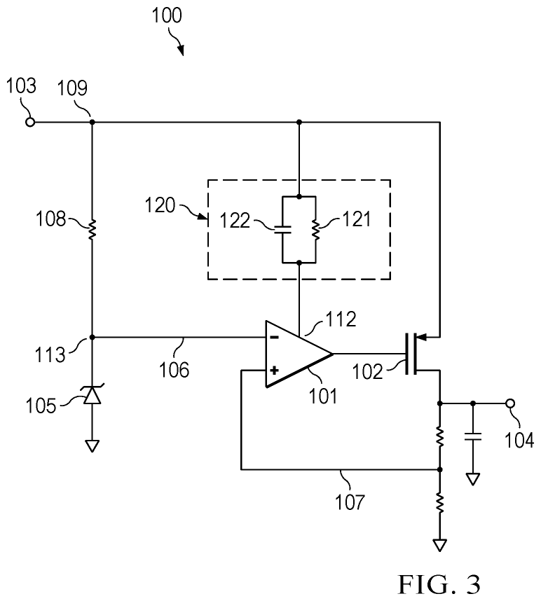

FIG. 3 illustrates an example open fault condition introduced into the voltage regulator circuit 100 of FIG. 1 according to an implementation. As illustrated in FIG. 1, the first common node 109 is coupled with the input power terminal 112 to supply power for op. amp. operation. However, to simulate a fault in the connection of the input power terminal 112 with the first common node 109, an open circuit fault condition 120 is shown in FIG. 3. Similar to the short circuit fault condition 117 illustrated in FIG. 2, the open circuit fault condition 120 includes fault model components such as a fault resistor 121 and a fault capacitor 122 coupled in parallel. However, other fault circuit arrangements may be used to simulate different types of open fault conditions. When activated during simulation, the effects of separating the input power terminal 112 from the first common node 109 via the open circuit fault condition 120 can be simulated.

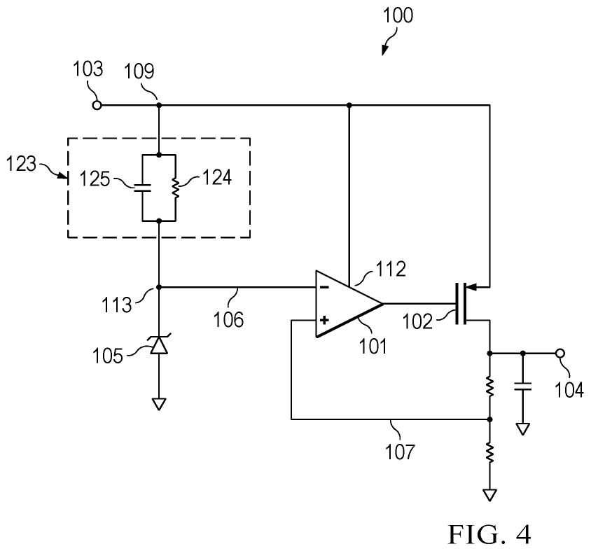

FIG. 4 illustrates an example replacement fault condition introduced into the voltage regulator circuit 100 of FIG. 1 according to an implementation. A replacement fault condition may represent alteration of one or more components to simulate a change to the replaced component (e.g., the resistor 108) due to one or more factors. For example, a change in the resistance characteristic of the replaced component due to age, exposure to extreme voltages or currents, or the like. As with the fault conditions 117, 120 illustrated in FIGS. 2 and 3, a replacement fault condition 123 includes fault model components such as a fault resistor 124 coupled in parallel with a fault capacitor 125. However, other types of replacement fault conditions may be used to simulate other electrical replacement conditions. Parametric faults, which are parametric variations beyond acceptable limits, can be modelled as replacement fault condition. One of the alternate mechanisms to model conditional or transient parametric fault conditions is to change and restore the identified parameter(s) of a replaced component 108 using the appropriate switch controls without necessarily replacing the component itself.

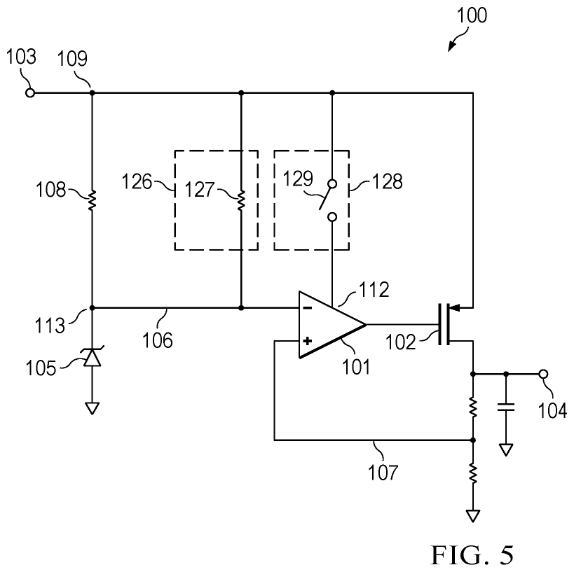

FIG. 5 illustrates an example of multiple fault conditions introduced into the voltage regulator circuit 100 of FIG. 1 according to an implementation. While the circuits of FIGS. 2-4 illustrate a single fault condition (e.g., fault conditions 117, 120, 123, respectively), more than one fault condition may be introduced into the voltage regulator circuit 100 for simulation. As illustrated, a short circuit fault condition 126 having a single fault model component such as a resistor 127 shorts the first and second common nodes 109, 113 together, while an open circuit fault condition 128 with a controllable switch fault model component 129 decouples the input power terminal 112 from the first common node 109.

The introductions and cessations of the fault conditions 126, 128 may occur simultaneously or at distinct times during simulation. For example, activation and deactivation of a short circuit fault simulated via the short circuit fault condition 126 may occur before the activation and deactivation of an open circuit fault simulated via the open circuit fault condition 128. In another example, activation of the open circuit fault simulated via the open circuit fault condition 128 may occur after activation of the short circuit fault simulated via the short circuit fault condition 126 but before the end of the short circuit fault simulation. Multiple conditional fault injection, either sequentially or otherwise, is used, for example, to analyze the behavior of the circuit due to a latent fault that is hidden from regular means of detection getting activated after certain time or due to a certain circuit condition or due to the effect of a transient fault injection and/or removal. Additionally, conditional or transient fault injection capability can be useful in analyzing transient noise injection effects on a circuit behavior including for transient stability analysis of feedback circuits. However, this adds complexity to the fault model by having noise sources modelled as either voltage or current sources.

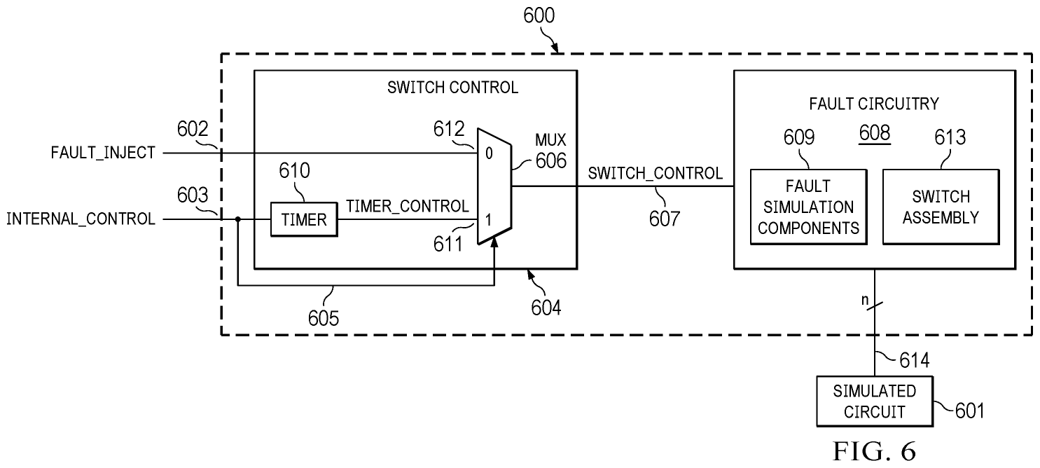

FIG. 6 shows block diagram of a conditional simulation fault model 600 according to an implementation. The conditional simulation fault model 600 is a user-definable simulation model configured to be positioned within the circuit to be simulated (e.g., the voltage regulator circuit 100 of FIG. 1) to allow a fault condition to be engaged with the simulated circuit 601 for simulating a fault condition and to allow the fault condition to be disengaged with the simulated circuit 601 for simulating circuit operation without the influence of the fault condition. Prior to the activation of the conditional simulation fault model 600 within the simulation, the disengaged state of the conditional simulation fault model 600 allows simulation of the circuit without the related fault. Activating or engaging the conditional simulation fault model 600 allows simulation of the circuit with the associated fault. Deactivation or disengagement of the engaged conditional simulation fault model 600 from the simulated circuit 601 allows, for example, circuit recovery post conditional or transient fault to be simulated.

The conditional simulation fault model 600 allows a fault to be both engaged and disengaged from the simulated circuit 601 during a single simulation. In this manner, situations such as circuit recovery after the removal of a fault may be simulated. In one embodiment, the activation and deactivation of the conditional simulation fault model 600 during the simulation is determined by control signals provided to a FAULT_INJECT signal input 602 and to an INTERNAL_CONTROL signal input 603. Alternatively, the INTERNAL_CONTROL may be implemented as a parameter within the simulation configuration. A switch control 604 receives an INTERNAL_CONTROL signal 605 from the INTERNAL_CONTROL signal input 603 for determining timer-based switch control or input-based switch control. For example, the INTERNAL_CONTROL signal 605 may be an active HIGH or LOW logic signal provided to a multiplexer 606 for selecting the source of switch control signals 607 provided to fault circuitry 608 for activation and deactivation of fault simulation components 609 designed to simulate a desired fault condition. The INTERNAL_CONTROL signal 605 is also provided to an internal clock generator or delay-based timing element i.e., a timer 610 having user-definable parameters to determine automatic activation and deactivation of the fault simulation components 609 to the simulated circuit 601 as described herein. Though a timer, which is an internal simulation time monitor, is illustrated as a means to achieve transient fault injection and removal, more generically it can be a monitor of any circuit (like gain, bandwidth, voltage or current bias, etc.), device or environmental condition parameter(s) (like temperature) that are accessible or made accessible from inside the fault model to accomplish a conditional fault injection and removal.

In one embodiment, a logic HIGH signal provided by the INTERNAL_CONTROL signal 605 selects a timer input channel 611 of the multiplexer 606 for determining insertion and cessation of a simulated fault condition within the simulation. User-definable parameters of the clock generator or timer 610 include a fault injection time (t_{fault_inject}), a fault cessation time (t_{fault_remove}), a fault lifetime (t_{fault_lifetime}), a fault period (t_{fault_period}), and a fault injection delay (t_{fault_init_delay}). In some examples, the fault injection delay can be factored into the fault injection time. The fault injection time may define one or more simulation time durations at which the defect or fault is to be injected or engaged with the simulated circuit 601 during the simulation. The fault cessation time (e.g., stop time) may define one or more simulation time durations or time instants at which the defect or fault is to be stopped or disengaged with the simulated circuit 601 during the simulation. The fault lifetime defines a simulation duration of any one particular engagement of the fault with the simulated circuit 601. In one embodiment, the fault lifetime is determined based on the fault injection and cessation times (e.g., the difference between the fault injection and cessation times). In another embodiment, only one of the fault injection time or fault cessation time is specified together with the fault lifetime. In this case, the unspecified parameter (e.g., the fault injection time or the fault cessation time) may be determined by subtracting or adding, respectively, the specified parameter from/to the fault lifetime parameter. The fault period may define a repeatable period for activating and deactivating the fault simulation components 609 within the simulation. In other words, the fault may be injected more than one time during the simulation. The fault injection delay may define an initial delay period with respect to the simulation start time (t=0) or the first fault injection time before inserting the first fault condition within the simulation.

In response to selecting the timer input channel 611 via the INTERNAL_CONTROL signal 605, any signal provided via the FAULT_INJECT signal input 602 to a FAULT_INJECT input channel 612 of the multiplexer 606 is ignored. To select the FAULT_INJECT input channel 612 for input to allow fault control via the FAULT_INJECT signal input 602, a logic LOW signal is provided by the INTERNAL_CONTROL signal 605, for example. In response to the logic LOW signal, the multiplexer 606 activates the FAULT_INJECT input channel 612 and deactivates the timer input channel 611. Accordingly, any input provided by the clock generator or timer 610 to the timer input channel 611 is ignored. The FAULT_INJECT signal input 602 represents an input channel allowing dynamic user control when the internal timer (e.g., the timer 610) is not used. Signals external to the simulation file provided to the FAULT_INJECT signal input 602 may be generated manually by a user during simulation (e.g., in a testbench environment). For example, a value of the FAULT_INJECT signal input 602 may be set HIGH or LOW by supplying an external signal during the simulation.

Whether provided by the clock generator or timer 610 or by the FAULT_INJECT signal input 602, the switch control signals 607 provided by the multiplexer 606 control a switch assembly 613 to engage or couple the fault simulation components 609 with the simulated circuit 601 or to disengage or decouple the fault simulation components 609 from the simulated circuit 601. Based on the type of fault condition being simulated, one or more connections 614 with the simulated circuit 601 are used.

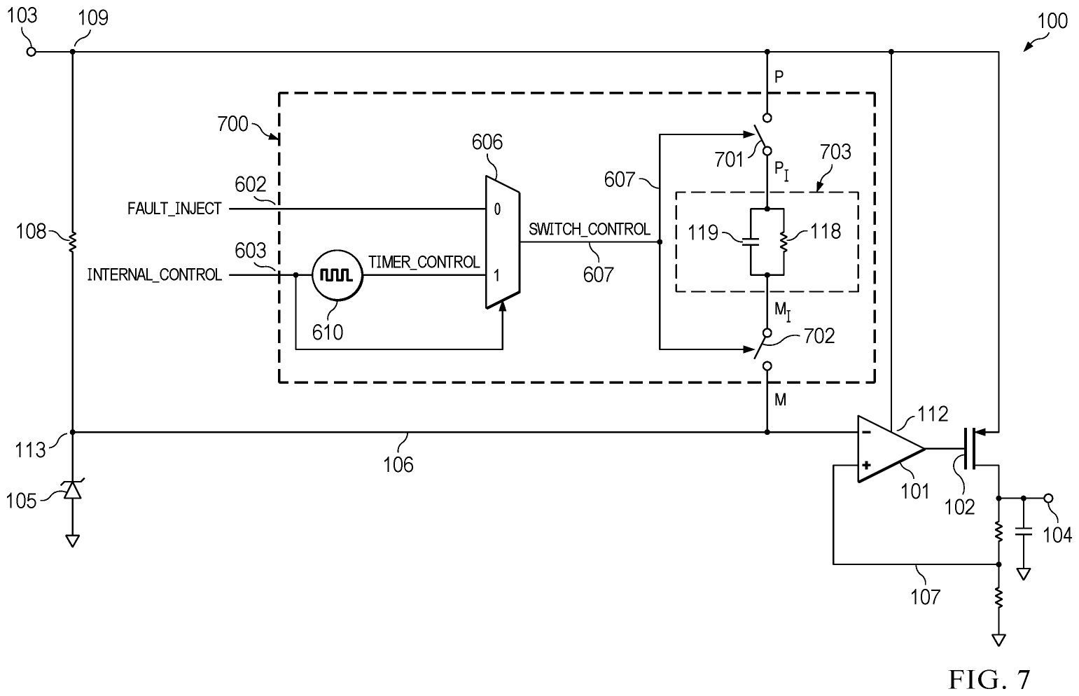

FIG. 7 illustrates an example circuit diagram of the circuit of FIG. 2 incorporating the conditional simulation fault model of FIG. 6 to control the short circuit fault condition according to an implementation. As illustrated, a simulation fault model 700 based on the conditional simulation fault model 600 of FIG. 6 is coupled with the voltage regulator circuit 100. A pair of controllable switches 701, 702 representing the switch assembly 613 of FIG. 6 are shown respectively coupled with the first common node 109 and the second common node 113. A fault simulation component assembly 703 including the fault resistor 118 and fault capacitor 119 of FIG. 2 is coupled to the controllable switches 701, 702.

Based on the switch control signals 607 provided by the multiplexer 606, the controllable switches 701, 702 engage or disengage the fault simulation components 703 with/from the voltage regulator circuit 100. For example, a logic HIGH switch control signal 607 may close the controllable switches 701, 702 to engage or insert the fault simulation components 703 with the voltage regulator circuit 100 while a logic LOW switch control signal 607 may open the controllable switches 701, 702 to disengage or remove the fault simulation components 703 from the voltage regulator circuit 100.

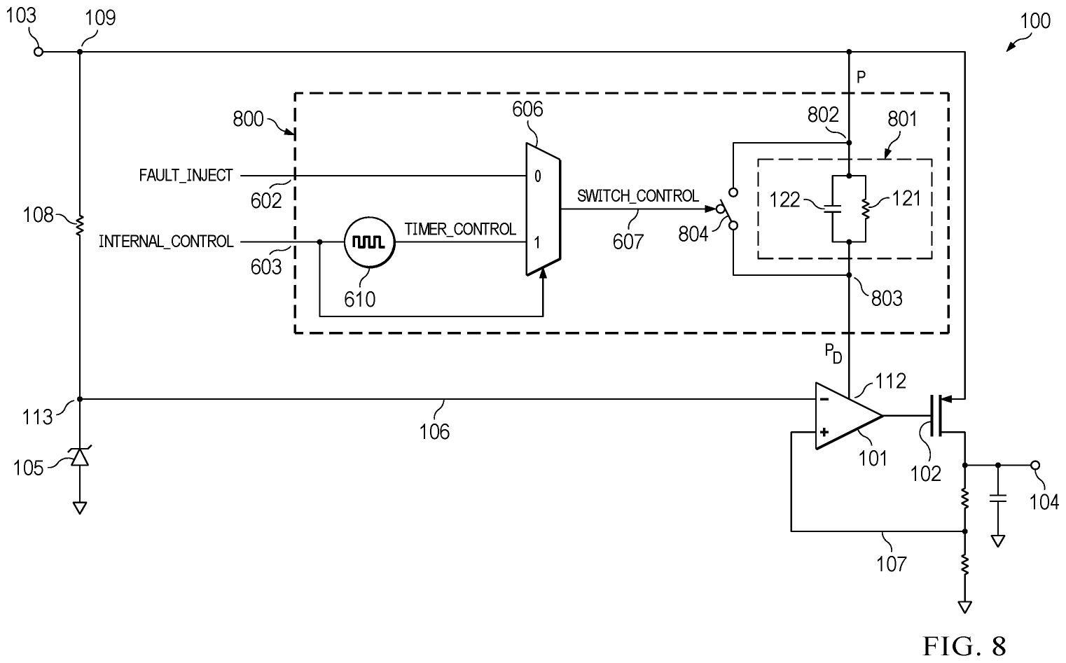

FIG. 8 illustrates an example circuit diagram of the circuit of FIG. 3 incorporating the conditional simulation fault model of FIG. 6 to control the open circuit fault condition according to an implementation. As illustrated, a simulation fault model 800 based on the conditional simulation fault model 600 of FIG. 6 is coupled with the voltage regulator circuit 100. A fault simulation component assembly 801 including the fault resistor 121 and fault capacitor 122 of FIG. 3 is coupled to a pair of nodes 802, 803 coupled to the first and second common nodes 109, 113. A controllable switch 804 represents the switch assembly 613 of FIG. 6 and is shown coupled between the pair of nodes 802, 803.

Based on the switch control signals 607 provided by the multiplexer 606, the controllable switch 804 engages or disengages the fault simulation components 801 with/from the voltage regulator circuit 100. In other words, controllable switch 804 can decouple the power terminal 112 of op. amp. 101 from the input voltage terminal 103. By decoupling the power terminal 112 from the input voltage terminal 103, controllable switch 804 couples the fault simulation component assembly 801 between power terminal 112 and the input voltage terminal 103. Deactivation of the controllable switch 804 removes the short circuit (e.g., low-resistance connection) between power terminal 112 from the input voltage terminal 103. Alternatively, to introduce the fault simulation component assembly 801, a parameter of the fault simulation component assembly 801 can be modulated. For example, the resistance of resistor 121 can be increased from zero or nearly zero (e.g., a short circuit) to a non-zero resistance. In the embodiment shown in FIG. 8, the controllable switch 804 is an inverted switch where a logic HIGH signal deactivates or opens the switch and where a logic LOW signal activates or closes the switch. For example, a logic HIGH switch control signal 607 (e.g., as illustrated in FIG. 8) may open the controllable switch 804 to engage or insert the fault simulation components 801 with the voltage regulator circuit 100 while a logic LOW switch control signal 607 may close the controllable switch 804 to short-circuit the pair of nodes 802, 803 together to disengage or remove the fault simulation components 801 from the voltage regulator circuit 100. In other embodiments, a non-inverted controllable switch 804 may be used, and the switch control signal 607 may be changed to control the controllable switch 804 as desired.

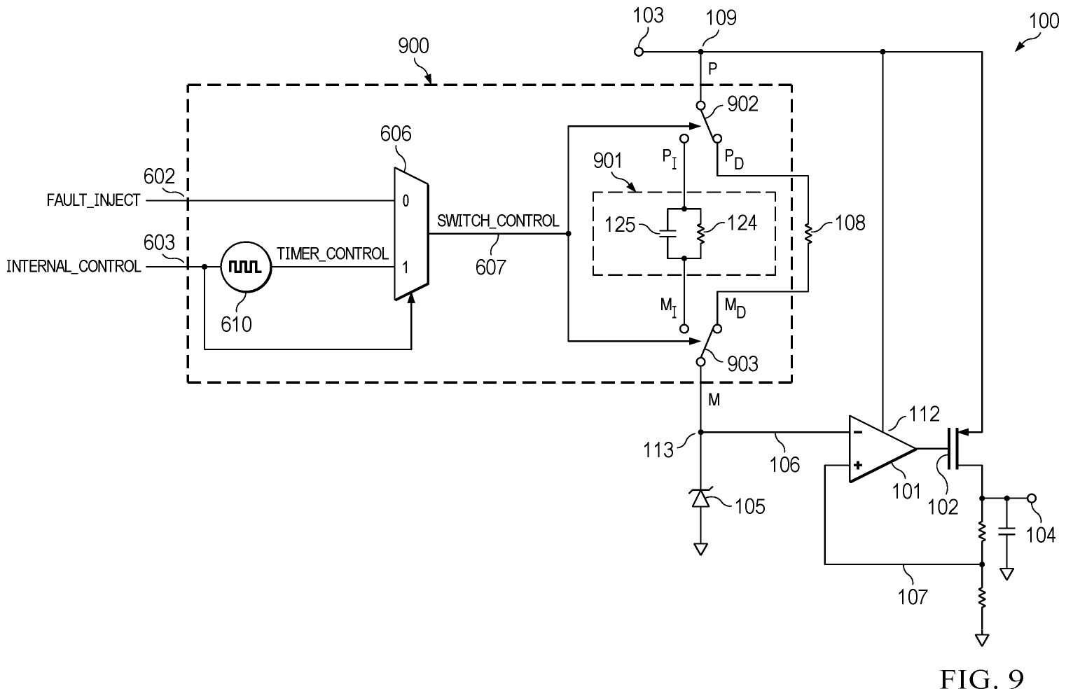

FIG. 9 illustrates an example circuit diagram of the circuit of FIG. 4 incorporating the conditional simulation fault model of FIG. 6 to control the replacement fault condition according to an implementation. As illustrated, a simulation fault model 900 based on the conditional simulation fault model 600 of FIG. 6 is coupled with the voltage regulator circuit 100. A fault simulation component assembly 901 including the fault resistor 124 and fault capacitor 125 of FIG. 4 is coupled to a pair of controllable switches 902, 903 coupled to the first and second common nodes 109, 113. The controllable switches 902, 903 represent the switch assembly 613 of FIG. 6 and are implemented in FIG. 9 as single pole, double throw switches also coupled with the resistor 108. In a first control state, the switches couple the resistor 108 between the first and second common nodes 109, 113, and in a second control state, the switches couple the fault simulation component assembly 901 between the first and second common nodes 109, 113.

Based on the switch control signals 607 provided by the multiplexer 606 in the first control state (e.g., a logic HIGH switch control signal 607), the controllable switches 902, 903 disengage the resistor 108 from the first and second common nodes 109, 113 and engage the fault simulation components 901 with the first and second common nodes 109, 113. In this manner, simulation of the voltage regulator circuit 100 with the replacement fault simulation component assembly 901 may be performed. Based on the switch control signals 607 provided by the multiplexer 606 in the second control state (e.g., a logic LOW switch control signal 607), the controllable switches 902, 903 disengage the fault simulation components 901 from the first and second common nodes 109, 113 and engage the resistor 108 with the first and second common nodes 109, 113. In this manner, simulation of the voltage regulator circuit 100 with the original resistor 108 may be performed.

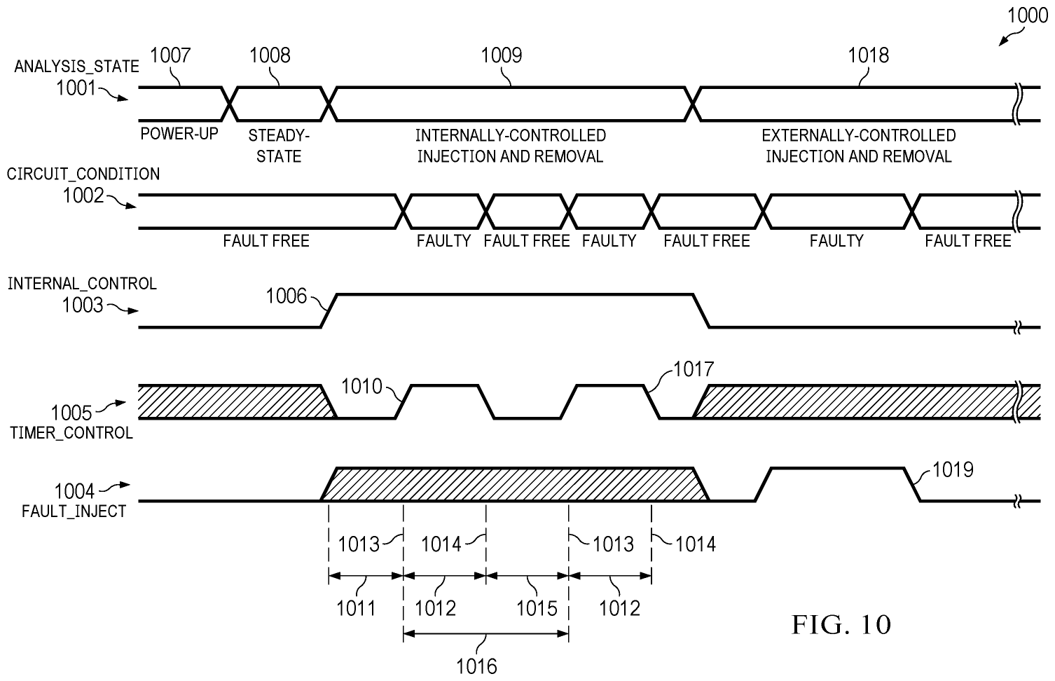

FIG. 10 illustrates an interface functional waveform 1000 showing waveforms of a system operation time sequence of simulations including fault episodes of the voltage regulator circuit 100 of FIG. 1 using a conditional simulation fault model 600 such as illustrated in FIGS. 7-9 according to an example. An ANALYSIS_STATE waveform 1001 illustrates state portions of the simulation sequence of the simulated circuit shown by the functional waveform 1000. A CIRCUIT_CONDITION waveform 1002 illustrates fault states of the simulated circuit at various portions of the simulation sequence. An INTERNAL_CONTROL waveform 1003 illustrates activation of fault and fault-free conditions based on the timer 610. A FAULT_INJECT waveform 1004 illustrates activation of a fault state based on this external signal state. A timer control (TIMER_CONTROL) waveform 1005 illustrates activation of a fault state based on the switch control signals 607 produced by the clock generator or timer 610 during periods of INTERNAL_CONTROL signal 605 control (e.g., during an active pulse 1006 of the internal waveform 1003).

During a power-up state portion 1007 and a steady-state portion 1008, the INTERNAL_CONTROL waveform 1003 is LOW, which controls the multiplexer 606 to select the FAULT_INJECT signal input 602. Accordingly, any signals from the timer (e.g., the TIMER_CONTROL waveform 1005) are ignored. While the FAULT_INJECT waveform 1004 remains low during power-up and steady-state operation, the circuit remains in a fault-free state. Though the fault injection and removal shown in this illustration are during the steady-state portion, they may be performed at any state of the circuit.

An application of the start of the active pulse 1006 transitions the ANALYSIS_STATE waveform 1001 into an internally-controlled fault injection and removal state 1009. During this state, any signals from the FAULT_INJECT waveform 1004 are ignored. Though the ANALYSIS_STATE is in the internally-controlled state 1009, the CIRCUIT_CONDITION 1002 remains fault free until application of a switch control signal pulse 1010 that injects the simulated fault condition into the simulation. A time delay 1011 between activation of the active pulse 1006 and activation of the switch control signal 1010 represents the fault injection delay (t_{fault_init_delay}). A fault lifetime (t_{fault_lifetime}) 1012, defined by a fault injection time (t_{fault_inject}) 1013 and a fault cessation time (t_{fault_remove}) 1014, places the CIRCUIT CONDITION 1002 into a faulty state wherein the simulated fault condition is active and injected into the simulation. In response to the expiration of the fault lifetime 1012 of the switch control signal pulse 1010, the simulated fault condition is deactivated and removed from the simulation during an inactivation period 1015 in which the circuit state 1002 returns again to the fault-free condition which in the course of simulation may recover to its original fault-free state. In one embodiment, the fault condition may be repeatedly inserted and removed from the simulation based on a fault period (t_{fault_period}) fault period 1016 defined by the fault lifetime 1012 and the inactivation period 1015. As illustrated, a subsequent switch control signal pulse 1017 is activated by the TIMER_CONTROL waveform 1005, which injects the fault condition into the simulated circuit again for the fault lifetime 1012. The clock generator or timer 610 (FIG. 6) produces a signal (e.g., of pulse width modulation (PWM) nature) having a plurality of pulse sequences that include the switch control signal pulses 1010, 1017 and additional pulse sequences while the active pulse 1006 remains active. Distinct fault injection and removal times occur with the respective rising and falling edges of each switch control signal pulse 1010, 1017.

The functional waveform 1000 of FIG. 10 shows a deactivation of the INTERNAL_CONTROL waveform 1003 following the subsequent switch control signal pulse 1017 to illustrate alternate operation of the simulation analysis during external control of fault condition engagement with the simulated circuit. In response to the deactivation of the INTERNAL_CONTROL waveform 1003, the ANALYSIS_STATE waveform 1001 is transitioned into an externally-controlled fault injection and removal state 1018. In response to an application of a switch control signal pulse 1019, the CIRCUIT_CONDITION 1002 transitions from a fault-free state into a faulty state. The switch control signal pulse 1019 may be activated and deactivated by a command external to the circuit under simulation or external to the simulation itself in a co-simulation environment (for example, analog and digital co-simulation or hardware and software co-simulation). In one embodiment, a user manually controls one or more of the activation and deactivation of the switch control signal pulse 1019. In another example, one or more of the activation and deactivation of the switch control signal pulse 1019 are controlled by an external signal representing a change in the environment in which the simulation circuit is operating such as a temperature of the environment.

As shown in FIG. 10, an application of sequential multiple fault injection, for example, can be useful to a) enable a continuous repeated noise injection causing different levels of impact to the circuit; and b) speedup simulation by injecting unrelated independent faults sequentially for such cases where the circuit fully recovers to reference fault-free state upon cessation of a previously injected fault. Portions of the FAULT_INJECT waveform 1004 and the TIMER_CONTROL waveform 1005 are shaded in FIG. 10. During these portions of the waveforms 1004, 1005, HIGH pulses are ignored for injecting faults. For example, based on the INTERNAL_CONTROL signal 1003 being LOW, HIGH or LOW values of the TIMER_CONTROL waveform 1005 are not able to inject or cease fault conditions, but fault injection or cessation is controlled by the state of FAULT_INJECT. Likewise, based on the INTERNAL_CONTROL signal 1003 being HIGH, HIGH or LOW values of the FAULT_INJECT waveform 1004 are not able to inject or cease fault conditions, but fault injection or cessation is controlled by the state of TIMER_CONTROL.

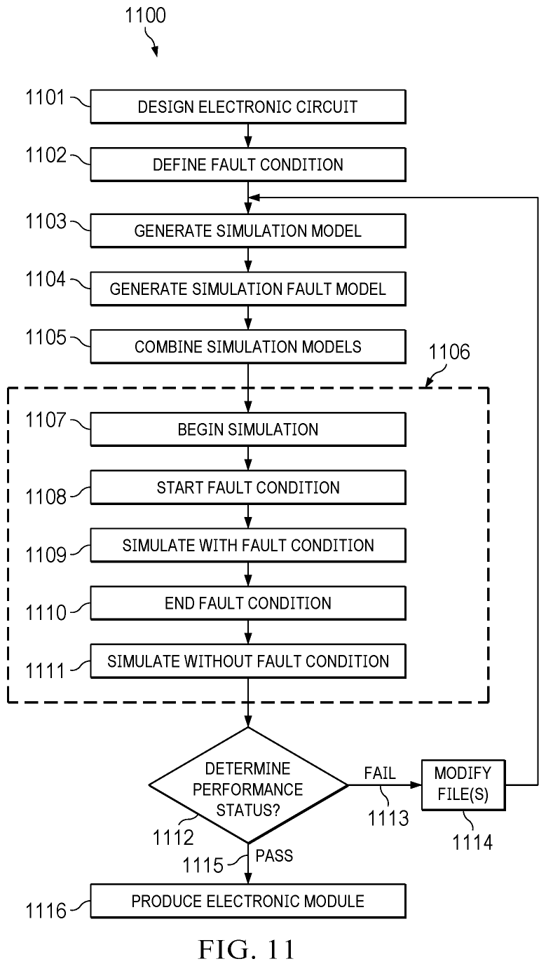

FIG. 11 illustrates a flow diagram of an operation 1100 for designing, simulating, and manufacturing a product in accordance with an example implementation. Operation 1100 begins with designing an electronic circuit for simulation testing at block 1101. At block 1102, a fault condition is defined for testing the electronic circuit during the simulation. As described herein, the fault condition is imposable on the electronic circuit during one or more portions of the simulation. Defining the fault condition includes determining the one or more simulation components used to simulate the fault condition. For example, a resistor having a predetermined resistance may simulate an open circuit or a short circuit condition depending on the desired scenario. Advantages of this disclosure include removal of the imposed fault condition during the simulation to determine or verify circuit behavior in response to removal of the fault condition, which can increase the accuracy of the simulation. For example, the changing and/or removal of fault characteristics in the simulation may result in a realistic simulation of the actual operation of a circuit. As described herein, fault conditions such as undesirable node shorting, node opening, or component replacement may be defined for simulation. Other types of defects and faults desirable for simulation and implementable using the embodiments described herein are also considered within the scope of this disclosure.

A simulation model is generated at block 1103 based on the designed electronic circuit. Additional example details of generating a simulation model can be found in commonly assigned U.S. patent application Ser. No. 18/481,711, entitled “Method and Apparatus for Generating a Real Number Based Circuit Model for Simulation,” filed on Oct. 5, 2023, which is incorporated by reference in its entirety. Based on the defined fault condition, a simulation fault model is generated at block 1104. Design of the simulation fault model may include setting simulation parameters defining enablement and disablement of the fault condition during the simulation. For example, fault model parameters may define enablement of the fault condition based on a timer pulse sequence including one or more repetitions of a timer pulse at a desired signal period. The fault model parameters may further define enablement as being controllable by signals produced externally from the simulation model. The generated simulation fault model is combined with the simulation model at block 1105.

A simulation 1106 of the combined simulation models includes beginning the simulation at block 1107. As illustrated in FIG. 10, beginning or starting the simulation may include a period for start-up and a period for steady-state operational analysis before imposing a fault condition on the simulated circuit. However, in some simulations, engagement of the fault condition at the beginning of or during power-up may be desired to analyze the associated circuit response to application of the fault condition during this portion of circuit operation.

A fault condition is imposed or started at block 1108. As stated above, starting the fault condition may occur simultaneously with starting the simulation of the circuit. In other embodiments, such as that illustrated in FIG. 10, the fault condition may be started after a period of steady-state operation. Circuit operation is simulated at block 1109 during enablement of the fault condition to analyze operation of the circuit influenced by the fault condition. During enablement of the fault condition, the characteristic(s) of the fault condition may be programmed to change. For example, the simulation model may include an impedance of the fault condition that is programmed to change while the fault condition is being imposed. The fault condition is ceased at block 1110 to disengage the fault condition from simulation of the circuit. The circuit operation without the fault condition is simulated at block 1111 to analyze circuit operation such as recovery after removal of the fault condition. Although this disclosure describes specific examples of starting, changing, and/or stopping of fault conditions, the starting, changing, and/or stopping of one or more fault conditions can be performed in any combination in other examples not expressly described in this disclosure. The starting, changing, and stopping of a fault condition can be programmed before the simulation and/or imposed during the simulation in a testbench environment.

Simulation results of the circuit may be analyzed at block 1112 to determine a performance status of the circuit in response to engagement and disengagement of the fault condition. If the simulation results indicate an unsatisfactory response 1113, the files related to the electronic circuit design and/or the defined fault condition may be modified at block 1114. If the fault simulation is performed during the pre-silicon or design phase of the circuit under analysis, there may be a possibility of changes in test vectors or design including modification to existing or adding new design for testability components (DFT). In case of post manufacturing analysis, it may result in modification of test vectors to improve coverage. Only in case of post manufacturing correlation analysis it may not result in modification to any files. The modified files may be used to perform a subsequent simulation to verify performance of the modified circuit and/or fault condition.

If the performance status indicates a pass or other satisfactory result 1115, the electronic circuit design may be manufactured by forming a pattern of the electronic circuit design on a semiconductor wafer to produce the designed electronic circuit in physical form at block 1116. In some examples, the designer or a foundry at the direction of the designer can create (e.g., by etching and/or patterning) the approved electronic circuit onto the semiconductor wafer using a simulation model. The designed electronic circuit may include an analog circuit, a digital circuit, and/or a mixed-signal circuit that is fabricated based on the approved design. For example, the designer can fabricate the approved electronic circuit based on the simulation model. In some examples, the design and fabrication steps may be performed by separate actors (i.e., a design company and a foundry).

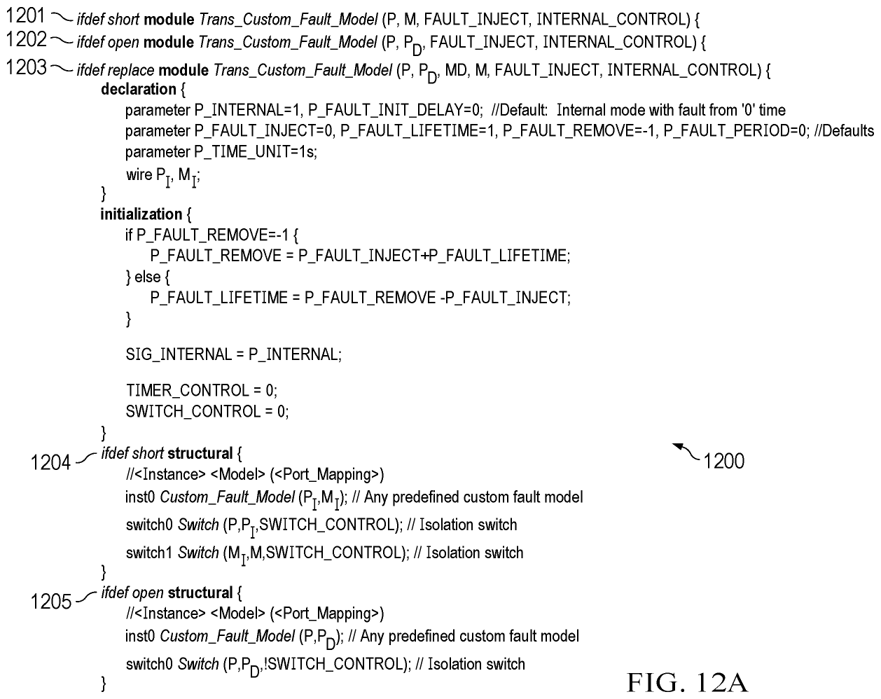

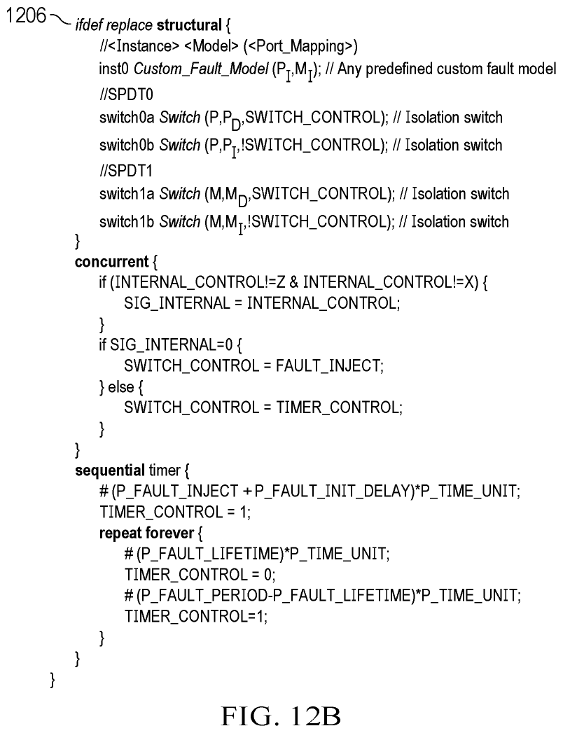

FIGS. 12A, 12B illustrate an example pseudocode 1200 for simulating defects/faults according to an embodiment, in the style of a typical hardware description language (HDL). In one example, the pseudocode 1200 may be executed by the simulation software during one or more of the steps of the simulation 1106 of FIG. 11. The pseudocode 1200 includes conditional module definitions 1201-1203 configured to model the fault conditions described herein. For example, conditional module definitions for a short circuit fault condition 1201, an open circuit fault condition 1202, and a replacement fault condition 1203 are included. Module interfaces (e.g., P, P_{D}, M_{D}, M, FAULT_INJECT, INTERNAL_CONTROL, etc.) included in the conditional module definitions 1201 are illustrated as signal names throughout FIGS. 6-10. The pseudocode 1200 further includes conditional structural blocks 1204-1206 executable during the simulation that set up targeted fault models and switch arrangements for each of the short, open, and replacement fault conditions (e.g., 117, 120, 123, 126, 128 of FIGS. 2-5). The declaration section deals with initial declaration of all parameters, internal signals and variables. The initialisation section deals with setting of initial conditions or states of previously declared parameters, internal signals and variables. The structural section deals with a structural net list style connection between instantiations of predefined circuit components (like Custom_Fault_Model and Switch). Such predefined circuit components (not shown) may themselves be in a behavioral description abstraction or in net list style structural description of primitive type leaf behavioral components (not shown) like resistor, capacitors, inductors, voltage sources, current sources, and other active or passive devices or macro models. The concurrent and sequential sections respectively describe the behavioural portions of the fault model that require concurrent circuit behavior (for example, conditional and perennial internal signal assignments) or a sequential execution behavior (for example, the timer).

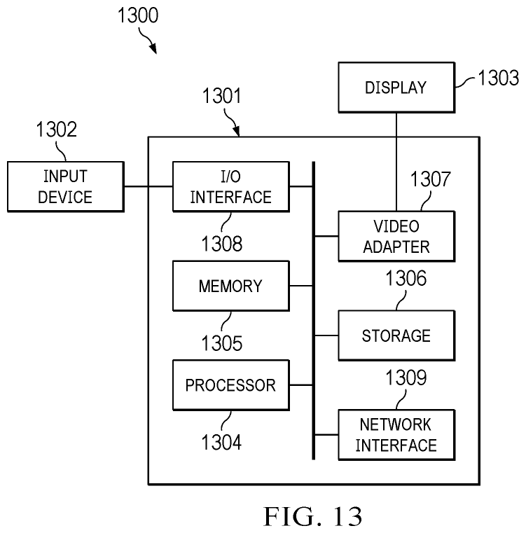

FIG. 13 is a block diagram of an example computer system 1300 that may be used to perform electronic circuit design simulation as described herein. For example, the computer system 1300 may be used to perform one or more of blocks 1103-1112 of the operation 1100 illustrated in FIG. 11. The computer system 1300 includes a processing unit 1301 coupled to one or more input devices 1302 (e.g., a mouse, a keyboard, or the like), and one or more output devices, such as a display screen 1303. The display screen 1303 may be used to display progress of the simulation described herein to allow a user to monitor the operational performance of the simulation. In some embodiments, the display screen 1303 may be touch screen, thus allowing the display screen 1303 to also function as an input device. The processing unit 1301 may be, for example, a desktop computer, a workstation, a laptop computer, a tablet, a dedicated unit customized for a particular application, a server, or the like. The display screen 1303 may be any suitable visual display unit such as, for example, a computer monitor, an LED, LCD, or plasma display, a television, a high-definition television, or a combination thereof. The display screen 1303 can be used, for example, to perform and display the simulation and display the performance status of the simulation such as that described herein.

The processing unit 1301 includes a processor 1304, memory 1305, a storage device 1306, a video adapter 1307, and an I/O interface 1308 connected by a bus. The bus may be one or more of any type of several bus architectures including a memory bus or memory controller, a peripheral bus, video bus, or the like. The processor 1304 may be any type of electronic data processor. For example, the processor 1304 may be a processor from Intel Corp., a processor from Advanced Micro Devices, Inc., a Reduced Instruction Set Computer (RISC), an Application-Specific Integrated Circuit (ASIC), or the like. The memory 1305, e.g., a non-transitory computer-readable medium, can be any type of system memory such as static random-access memory (SRAM), dynamic random-access memory (DRAM), synchronous DRAM (SDRAM), read-only memory (ROM), a combination thereof, or the like. Further, the memory 1305 can include ROM for use at boot-up, and DRAM for data storage for use while executing programs.

The storage device 1306, e.g., a non-transitory computer-readable medium, can include any type of storage device configured to store data, programs, and other information and to make the data, programs, and other information accessible via the bus. In one or more embodiments, the storage device 1306 stores software instructions to be executed by the processor 1304 to perform embodiments of the methods described herein. The storage device 1306 may be, for example, one or more of a hard disk drive, a magnetic disk drive, an optical disk drive, a solid-state drive, or the like.

The video adapter 1307 and the I/O interface 1308 provide interfaces to couple external input and output devices to the processing unit 1301. The processing unit 1301 also includes a network interface 1309. The network interface 1309 allows the processing unit 1301 to communicate with remote units via a network (not shown). The network interface 1309 may provide an interface for a wired link, such as an Ethernet cable or the like, or a wireless link. The computer system 1300 may also include other components not specifically shown. For example, the computer system 1300 may include power supplies, cables, a motherboard, removable storage media, cases, and the like.

This disclosure has attributed functionality to the processing unit 1301 and processor 1304. The processing unit 1301 and processor 1304 may include one or more processors. Processing unit 1301 and processor 1304 may include any combination of integrated circuitry, discrete logic circuitry, analog circuitry, such as one or more microprocessors, microcontrollers, digital signal processors, application specific integrated circuits, central processing units, graphics processing units, field-programmable gate arrays, and/or any other processing resources. In some examples, processing unit 1301 and processor 1304 may include multiple components, such as any combination of the processing resources listed above, as well as other discrete or integrated logic circuitry, and/or analog circuitry.

The techniques described in this disclosure may also be embodied or encoded in an article of manufacture including a non-transitory computer-readable storage medium, such as memory 1305 and storage 1306. Example non-transitory computer-readable storage media may include RAM, ROM, programmable ROM, erasable programmable ROM, electronically erasable programmable ROM, flash memory, a solid-state drive, a hard disk, magnetic media, optical media, or any other computer readable storage devices or tangible computer readable media. The term “non-transitory” may indicate that the storage medium is not embodied in a carrier wave or a propagated signal. In certain examples, a non-transitory storage medium may store data that can, over time, change (e.g., in RAM or cache).

As an alternative to software simulation, the techniques of this disclosure can be implemented in silicon for on-chip evaluation, for example, to evaluate transient behaviour in the presence of functional workload execution. The techniques of this disclosure can be implemented in hardware under different normal mode and stress mode operating conditions. The techniques of this disclosure can also be implemented in hardware during life-time operation to ascertain the impact of aging. In other words, these techniques can be a simulation model or a hardware implementation on-chip. Additional example details of hardware fault emulation can be found in commonly assigned U.S. Patent Application Publication No. 2023/0143500, entitled “Tests for Integrated Circuit (IC) Chips,” filed on Jul. 22, 2022, which is incorporated by reference in its entirety.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. A method comprising:
creating an electronic circuit design having a plurality of electronic components;
defining a fault condition imposable during a simulation of the electronic circuit design;
generating a simulation model based on the electronic circuit design;
generating a simulation fault model representing the fault condition;
executing a simulation of the simulation model to simulate operation of the electronic circuit design; and
during the execution of the simulation:
controlling the simulation fault model to begin an imposition of the fault condition within the simulation model;
simulating circuit behavior of the simulation model in response to the imposition of the fault condition;
controlling the simulation fault model to cease the imposition of the fault condition within the simulation model; and
simulating circuit behavior of the simulation model in response to the cessation of the imposition of the fault condition.

2. The method of claim 1, wherein:
the simulation model comprises:
a plurality of simulation components, each simulation component configured to simulate operation of a corresponding electronic component of the electronic model design during the simulation execution; and
a plurality of simulation nodes defining an interaction of the plurality of simulation components with each other during the simulation execution; and
the simulation fault model comprises:
at least one fault model component configured to allow simulation of the fault condition during the simulation execution;
a switch assembly defining an interaction of the at least one fault model component with the simulation model during the simulation execution; and
a switch control configured to control the switch assembly during the simulation execution.

3. The method of claim 2, wherein the fault condition comprises a shorting fault defining an electrical coupling between a pair of simulation nodes of the simulation model; and
wherein the switch control is configured to:
control the switch assembly into a conduction mode in response to the imposition of the fault condition to couple the at least one fault model component between the pair of simulation nodes; and
control the switch assembly into a non-conduction mode in response to the cessation of the fault condition to decouple the at least one fault model component from the pair of simulation nodes.

4. The method of claim 2, wherein the fault condition comprises an opening fault defining an electrical decoupling of a simulation component of the simulation model from a simulation node of the simulation model; and
wherein the switch control is configured to:
control the switch assembly into a non-conduction mode in response to the imposition of the fault condition to:
decouple the simulation component from the simulation node; and
couple the at least one fault model component between the simulation component and the simulation node; and
control the switch assembly into a conduction mode in response to the cessation of the fault condition to:
decouple the at least one fault model component from the simulation component and the simulation node; and
couple the simulation component with the simulation node.

5. The method of claim 2, wherein the fault condition comprises a replacement fault defining a substitution of a simulation component of the simulation model with the at least one fault model component; and
wherein the switch control is configured to:
control the switch assembly into a first conduction mode in response to the imposition of the fault condition to:
decouple the simulation component from a pair of the simulation nodes; and
couple the at least one fault model component between the pair of the simulation nodes; and
control the switch assembly into a second conduction mode in response to the cessation of the fault condition to:
decouple the at least one fault model component from the pair of the simulation nodes; and
couple the simulation component between the pair of the simulation nodes.

6. The method of claim 2, wherein the simulation fault model further comprises:
a first input coupled with the switch control;
a second input coupled with the switch control; and
a fault timer coupled with the second input and configured to:
track an imposition time of the fault condition in response to a control signal supplied to the second input; and
generate a fault condition timer signal based on the imposition time;
wherein the switch control is configured to begin and cease the imposition of the fault condition in response to the fault condition timer signal.

7. The method of claim 6, wherein switch control is further configured to begin and cease the imposition of the fault condition in response to a control signal supplied to the first input.

8. The method of claim 7, wherein switch control is further configured to:
receive a control value supplied to the second input, wherein the control value is a control parameter determined prior to the generating of the simulation fault model; and
control the imposition of the fault condition in response to the control signal supplied to the first input based on the control value.

9. The method of claim 1, further comprising forming a pattern of the electronic circuit design on a semiconductor wafer after execution of the simulation.

10. The method of claim 1, further comprising receiving user input during the execution of the simulation;
wherein controlling the simulation to begin the imposition of the fault condition is in response to the user input.

11. An apparatus comprising:
one or more computer readable storage media;
program instructions stored on the one or more computer readable storage media, the program instructions executable by a processing system to direct the processing system to:
generate a simulation file based on a simulation model of a plurality of electronic components of an electronic circuit and based on a simulation fault model of a fault condition;
execute the simulation file to simulate operation of the plurality of electronic components;
activate the simulation fault model during the execution of the simulation file to simulate application of the fault condition to one or more of the simulated plurality of electronic components;
simulate behavior of the plurality of electronic components in response to the activation of the fault condition;
deactivate the simulation fault model during the execution of the simulation file to simulate removal of the fault condition from the one or more of the simulated plurality of electronic components; and
simulate behavior of the plurality of electronic components in response to the deactivation of the fault condition.

12. The apparatus of claim 11, wherein the program instructions further direct the processing system to:
activate a fault timer during the execution of the simulation file, the fault timer configured to control the activation and deactivation of the simulation fault model.

13. The apparatus of claim 12, wherein the program instructions further direct the processing system to:
control a switch assembly based on a fault injection time of the fault timer to activate the simulation fault model; and
control the switch assembly based on a fault removal time of the fault timer to deactivate the simulation fault model.

14. The apparatus of claim 13, wherein fault injection time occurs after a fault delay time initiated in response to the activation of the fault timer.

15. The apparatus of claim 13, wherein the fault timer comprises a pulse width modulation (PWM) signal comprising a plurality of pulse sequences, each pulse sequence comprising an on-state pulse and an off-state pulse;
wherein the fault injection time corresponds with a rising edge of each on-state pulse; and
wherein the fault removal time corresponds with a falling edge of each on-state pulse.

16. The apparatus of claim 11, wherein the program instructions further direct the processing system to:
receive a signal external to the simulation file; and
in response to receiving the signal:
execute the activation of the simulation fault model; and
execute the deactivation of the simulation fault model.

17. The apparatus of claim 11, wherein the program instructions that direct the processing system to activate the simulation fault model further direct the processing system to simulate a short circuit fault during the activation of the simulation fault by inserting a connection of one or more fault components in parallel with one or more electronic components of the plurality of electronic components.

18. The apparatus of claim 11, wherein the program instructions that direct the processing system to activate the simulation fault model further direct the processing system to simulate an open circuit fault during the activation of the simulation fault by:
decoupling a predetermined electronic component of the plurality of electronic components from a predetermined node; and
coupling one or more fault components between the predetermined electronic component and the predetermined node.

19. The apparatus of claim 11, wherein the program instructions that direct the processing system to activate the simulation fault model further direct the processing system to simulate an alternate component behavior fault during the activation of the simulation fault by:
decoupling a predetermined electronic component of the plurality of electronic components from the simulation model; and
coupling one or more fault components in place of the predetermined electronic component within the simulation model.

20. The apparatus of claim 11, wherein the processing system is configured to receive a user input during the execution of the simulation; and
wherein the program instructions to control the simulation to begin the imposition of the fault condition comprise one or more instructions to control the simulation to begin the imposition of the fault condition in response to the user input.
